(19) United States
(12) Patent Application Publication
(10) Pub. No.: US 2013/0194104 A1
(43) Pub. Date: Aug. 1, 2013

(54) Warning lamp column

(71) Applicant: Christian Hoehler, DE-Wellendingen (DE)

(72) Inventor: Christian Hoehler, DE-Wellendingen (DE)

(21) Appl. No.: 13/694,725

(22) Filed: Dec. 28, 2012

(30) Foreign Application Priority Data
Dec. 29, 2011 (DE) 10 2011 122 531.9

(51) Int. Cl. G08B 7/06

(52) U.S. Cl. CPC G08B 7/06
USPC 340/815.4

(57) ABSTRACT

A warning lamp column is proposed for the visual display of at least one operating state of a technical device such as a machine, a plant, a vehicle or the like, having at least one warning unit (1) comprising at least one warning lamp element and/or a light-emitting diode and/or a warning sound generator, in which a holding device (2) is arranged following the warning unit (1) in the direction of the longitudinal axis of the warning lamp column, the warning unit (1) having at least one sheath element (8) formed substantially as a tube element (8) for sheathing the warning lamp element and/or the light-emitting diode and/or the warning sound generator, which satisfies particularly aesthetic requirements and in particular can be produced particularly economically beneficially. According to the invention, this is achieved in that the holding device (2) and the sheath element (8) of the warning unit (1) are formed as column elements (1, 2, 8) transparent to visible light.

The invention relates to a warning lamp column for the visual display of at least one operating state of a technical device, having at least one warning unit comprising at least one warning lamp element and/or a light-emitting diode and/or a warning sound generator according to the preamble of claim 1.

### PRIOR ART

For many years, signal columns having a plurality of replaceable modules for signaling operating states of machines such as machine tools, production belts or the like have already been known. In addition, pre-configured warning lamp columns having predefined, firmly fixed and/or non-replaceable warning lamp units or sections exhibiting different colors are already known. Thus, in general, differently colored display modes are known, in order for example to identify an operating state “everything in order” or “magazine empty”, etc. by color. In addition, acoustic signal generators such as piezo buzzers or a horn or the like can be integrated into the warning lamp column.

Warning lamp columns of this type are often used in industry or in commercial applications, the columns normally being fitted in an elevated location or at an easily visible point directly on the appliance or in the vicinity of the area of a supervisor, e.g. on a building wall or on the building or room ceiling, etc. Above all in industrial applications, the economy and the operational reliability or the suitability in practice is normally the decisive question in the configuration of corresponding warning lamp columns.

However, warning lamp columns of this type are also used in (commercial) applications, not only the operational reliability or the economy or the like but, primarily, also aesthetic aspects playing an important, possibly even critical, role. This is primarily of high relevance in areas with high customer or visitor numbers.

For such, more “design-oriented applications”, signal columns are already known, warning units or replaceable modules having a whitish, milky appearance, in particular of the dome, often being used, and plinths and covers of corresponding warning lamp columns being implemented in stainless steel or in a stainless steel design. However, this leads to comparatively high costs.

### OBJECT AND ADVANTAGES OF THE INVENTION

By contrast, it is an object of the invention to propose a warning lamp column of the type mentioned at the beginning which satisfies particular aesthetic requirements and in particular can be produced particularly economically beneficially.

Starting from a warning lamp column of the type mentioned in the introduction, this object is achieved by the features of claim 1 and/or 2. By means of the measures cited in the dependent subclaims, advantageous embodiments and developments of the invention are possible.

Accordingly, a warning lamp column according to the invention is distinguished firstly by the fact that the holding device and the sheath element of the warning unit are formed as column elements transparent to visible light.

With the aid of the invention, it is possible to implement a signal column that is virtually not noticed or even not noticeable by individuals when it is switched off or not illuminated. This means that the warning lamp column according to the invention is very unobtrusive, so that, on an industrial appliance or at the fixing location, it is barely or even completely not seen when it is switched off. Only when the warning lamp elements or light-emitting diodes or the like illuminate in an appropriate warning color and in the warning state do corresponding individuals notice the warning lamp column according to the invention.

As the material transparent to visible light for the advantageous column elements/components according to the invention, in addition to glass, appropriate plastics such as Plexiglas can primarily preferably be used. In this way, as compared with the stainless steel used in the prior art, considerably more cost-effective warning lamp columns can also be implemented.

In order to achieve the object of the invention, a warning lamp column according to the preamble of claim 1 or in combination with the aforementioned feature can also be formed in such a way that the warning lamp column has a continuous, uniform or identical shell or contour substantially extending over the sheath elements and the holding device. This continuous, identical or homogenous shell leads to a uniform or homogenous appearance of the entire warning lamp column and can be implemented in different ways.

For example, a one-piece tube can be provided, which comprises both the sheath elements of the warning units and also the holding device. Here, the one or more warning units can possibly be mounted jointly or as a one-piece structural unit or separately as separate units during production. This means that, in this variant, by means of the mounting and placing, the areas comprising “warning unit” or illuminating area and the area comprising “holding device” or the foot of the column are defined and fixed. In this way, very high flexibility is achieved in arranging the various column areas.

It is also possible, for example, for a plurality of segments having the same or identical shell to be used as holding device and as warning unit or warning units during the production of the warning lamp column according to the invention and, advantageously, arranged beside one another or adjacent to one another in the axial direction and advantageously joined to one another. This joint can be designed both to be detachable, in particular detachable without a tool, or quite possibly firmly fixed to one another or quasi-non-detachably fixed to one another integrally or materially, possibly with the aid of an additive such as an adhesive.

It is conceivable that, for example, materials or column elements according to the invention which are only a little or barely transparent to visible light are used, so that, for example, a uniform, identical and continuous shell character with respect to (chromatic) color and surface can be implemented. For example, shading or coloring of the sheath elements and of the holding device in an extremely wide range of (chromatic) colors can be provided. For example, a continuously black or gray or silvery or white, glossy or matt sleeve can be provided, the warning unit illuminating in an appropriate warning color such as red, yellow, blue or green when switched on and on the basis of a comparatively intense or more intense intensity. In this way, the warning lamp column according to the invention is likewise comparatively unobtrusive when switched off. Said column, for example as a tube or column with an unobtrusive design when switched off, is likewise barely (annoyingly) noticed and fitted to the technical appliance or at the location of use to be monitored and only noticed as a result of lighting up as a warning lamp column according to the invention. For instance, what is called smoked glass or advantageously blackened or shaded plastics such as plastic tubes or the like can also be used as a shell.

In principle, it is thus also conceivable to design the entire warning lamp column according to the invention substantially in the respective or individual color of the corresponding company or the appliance to be monitored, for example in magenta, in seed green, in yellow, in orange etc., one section or the respective warning unit of the column lighting up in the warning color in the warning state or as a result of the lighting elements or LED illuminating. Here, for example, (slight) colored shading or shadowing of the entire column, in particular produced from a Plexiglas tube or the like, is of special aesthetic advantage. If appropriate, areas shaded to different extents are provided, for example the warning unit/s is/are shaded more lightly or less intensely than the holding device, without a difference with respect to the differently highly shaded areas being noticeable from the outside or to a person viewing the column as a result when the latter is switched off.

In an advantageous embodiment of the invention, the holding device is substantially formed from a tube element like the sheath element of the warning unit, the tube element of the holding device, viewed in the direction of the longitudinal axis of the warning lamp column, having a different length, in particular a greater length, than the tube element of the sheath element. This measure achieves the situation where preferably identical tube elements are used both for the holding device and for what is known as the plinth or foot of the warning lamp column and also for the warning unit or for a replaceable module, although these generally have different lengths. For example, comparatively short warning units or replaceable modules, that is to say short lengths of the warning units in the longitudinal direction of the warning lamp column, are usually provided. On the other hand, the holding device or the plinth or foot of a corresponding warning lamp column is frequently substantially longer, for example many times or three to ten times longer, than an individual warning unit.

The shell and/or the tube elements of the sheath element or elements and the tube elements of the holding device preferably have substantially the same external diameter or geometric dimensions and in particular the same shape or silhouette. In this way, it is possible to generate an advantageous, uniform, continuously identical shell which, even in the case of a multi-part design of the warning lamp column according to the invention, generates the visual appearance of a one-piece warning lamp column. In first trials with test individuals, it has been shown that such a warning lamp column is particularly unobtrusive and inconspicuous when switched off.

In principle, the warning unit and the sheath element can have elevations or depressions or reflectors or the like, preferably on the inside of the sheath element, so that the warning light generated in the interior of the warning unit is propagated in an advantageous way. For example, elevations and depressions and/or flutes, grooves, etc, of this type can advantageously be formed in order to generate advantageous deflection of light.

A milky surface or milky character of the sheath element and of the holding device is possible. The holding device and the sheath element of the warning unit are preferably formed as a glass-clear tube element. As a result, appropriate individuals barely notice the warning lamp column according to the invention in the case of a conventional intended use in conventional areas or locations, since the objects behind the warning lamp column according to the invention are nevertheless visible or shine through, possibly somewhat optically distorted or blurred. As a result, for individuals that are correspondingly present, the impression is given that the warning lamp column according to the invention is invisible or is “swallowed” by the surroundings or the background and is only noticed when viewed more closely.

In a special development of the invention, the warning unit and/or the holding device has at least one electric conductor for conducting electric power and/or electric signals. In this way, the power supply and signaling can advantageously be implemented.

The conductor preferably has at least one item of transparent and/or glass-clear electrical insulation. Above all when transparent or glass-clear sheath elements and/or holding devices are used, the electric conductors and the electronic components are visible from outside. Here, by means of using appropriately advantageous electrical insulation and/or unobtrusive or white or largely transparent electronic carriers and printed circuit boards or the like, the perceptibility for corresponding individuals when the warning lamp column according to the invention is switched off is further reduced or made more difficult. Thus, above all whitish or grayish or even components that are transparent to visible light or glass-clear are of particular advantage.

In principle, it is conceivable for the sheath element/s and/or the holding device to be designed as electrical insulation transparent to visible light and/or glass-clear. For example, a sheath element and/or holding device formed as a Plexiglas tube can implement the electrical insulation between two electric conductors according to the invention. This means that a conductor track or an electric conductor applied to the inside can already be electrically insulated with respect to a further electric conductor by the Plexiglas.

Preferably, a metal wire, in particular a copper wire, is used as electric conductor according to the invention. However, electrically conductive plastics or carbon conductors are entirely conceivable, which to some extent can themselves be formed to be transparent to visible light or virtually glass-clear. Accordingly, the electric conductor according to the invention is also not or barely noticeable. In advantageous application or coating methods, preferably on the inside of the holding device and/or the sheath elements or warning units, the electric conductor can be applied by printing, varnishing, spraying or the like, if appropriate even under the comparatively restricted space conditions in an appropriate tube element.

Preferably, a metal wire is provided or an electric conductor has a conduction cross section ≦0.05 mm. Here, for example, use can be made of a conductor having an overall cross section of 0.25 mm, a transparent varnish or plastic tube, etc, for example, advantageously being provided as electrical insulation.

In order to improve the imperceptibility or unobtrusiveness of the electric conductor, an overall cross section of ≦0.15 mm and a conductor cross section of ≦0.02 mm or even an overall cross section of ≦0.1 mm and a wire cross section or conductor cross section of ≦0.01 mm can also be provided. In particular cases, an electric conductor having an overall cross section of ≦0.05 mm and a conductor cross section of ≦0.003 mm can even be used. For example, what is known as a transformer wire, which is commercially available, can be used for this purpose. It has been shown that, in practical tests, electric conductors of this type are virtually invisible to individuals.

In principle, at least one fixing device for the detachable fixing of the warning unit in the assembled operating state can advantageously be provided. For example, this can be a bayonet catch or screw connection or plug-in or clamping connection or the like.

Preferably, an adhesive is provided to join the sheath element of the warning unit to the holding device and/or to a further sheath element of the warning unit and/or a cover element. For instance, a plastic adhesive is used when plastic tubes or the like are used. In the case of adhesives, it is of particular advantage that these can be applied comparatively thinly and can be used for an extremely wide range of materials. As a result of the low thickness or the thin application, the adhesive is also virtually unobtrusive.

In general terms, a welding method, in particular a plastic welding method or ultrasonic welding method, can also be provided in order to join the components or the warning unit to the holding device and/or a further warning unit and/or a cover element.

In a preferred embodiment of the invention, a warning lamp column is implemented, for example, by bonding individual Plexiglas tube segments together. In this case, the holding device or the “foot” or “plinth” of the warning lamp column, just like the individual warning units, can advantageously be formed from a standardized Plexiglas tube. As a result of using identical structural elements or tubes, which are advantageously joined, preferably bonded together, a uniform continuous and identical design over the full height of the warning lamp column according to the invention is produced. In a corresponding way, a continuous, identical shell can be produced with particularly little constructional effort. This is economically particularly beneficial.

Preferably, not just one warning unit but a plurality of warning units are provided, which are preferably prepared as sheath elements by means of separated or laser-cut or sawn-off Plexiglas tubes and in which electronic components and the warning lamp elements and/or light-emitting diodes etc are arranged. In addition, for example, a segment or this warning unit has a separate cable for power supply, the cable advantageously being implemented very thinly. The cable or the electric conductor can, for example, “wander through” the other components or segments such as other warning units or the holding device according to the invention. The cable is advantageously led as far as the appliance or fixing location or a fixing flange or the like. This wandering or leading of the electric conductor or the thin cable through is advantageously carried out in such a way that, if possible, it is not aligned or tensioned in a straight line; instead, it has surprisingly been shown that an irregular or loose arrangement or suspension of the electric conductor and thus the formation of a wavy electric conductor without any predefined uniform structure is particularly difficult for individuals to see or is particularly unobtrusive. Appropriately waved or irregularly shaped electric conductors are “swallowed” by the background or the surroundings and thus no longer noticed.

In principle, round tube elements and also angular, square, elliptical or otherwise profiled tube elements can be used in accordance with the invention.

The invention can be adapted individually to specific customer requests and, in addition, can be produced particularly economically beneficially, for example by using standardized Plexiglas tubes, as already explained by way of example above.

### EXEMPLARY EMBODIMENT

An exemplary embodiment of the invention is illustrated in the drawing and will be explained in more detail below by using the single FIGURE.

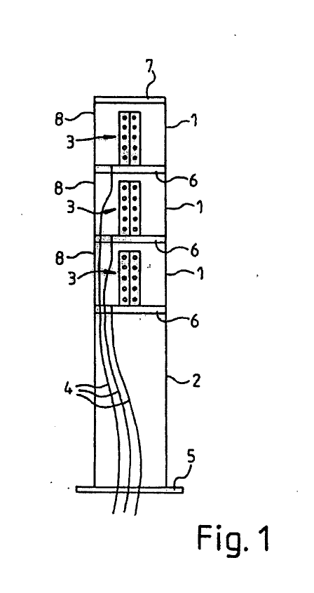

In FIG. 1, a warning lamp column or signal column according to the invention, which comprises three warning units 1, is illustrated schematically. The three warning units 1 or light-emitting segments 1 are arranged directly following or adjacent to a foot 2 or holding device 2 or plinth 2 in the longitudinal direction of the warning lamp column. The foot 2 holds or carries the light-emitting segments 1 at or in the envisaged position thereof and it is advantageously fixed and arranged at the respective fixing location by means of a fixing flange 5.

A warning unit 1 comprises a dome 8 and a sheath element 8, which is preferably implemented from a Plexiglas tube having an appropriate length in the axial direction. All three warning units 1 or Plexiglas tube segments 8 are preferably equally long, so that a uniform visual impression is produced. In addition, this can also be produced serially in a standardized and advantageous way and, furthermore, electronic carriers 3 with, for example, a plurality of light-emitting diodes 3 can be produced in a standardized manner and in comparatively large numbers and fixed in the dome 8 in the warning unit 1, for example bonded on.

The light-emitting diodes 3 and the electronic carriers are preferably arranged in the interior of the warning units 1, for example a plurality of LEDs both in the longitudinal direction and/or a plurality of LEDs in the circumferential direction, so that an all-round emission characteristic is implemented. For example, electronic carriers with light-emitting diodes or light-emitting elements arranged on both sides are provided. As an alternative to this, a use of a plurality of electronic carriers having light-emitting diodes arranged on one side, which are arranged around the central longitudinal axis, for example, preferably in a circle or as a polygon, can also be provided.

Electronic carriers and light-emitting diodes 3 of this type can be arranged and fixed on a carrier or electronic carrier arranged transversely with respect to the longitudinal axis. In principle, it is advantageous to form the electronic carriers or electronic components used as unobtrusively as possible, which means preferably colorlessly or even transparently or in the desired hue or color shade, in order not to have any detrimental effect on the unobtrusiveness of the warning lamp column according to the invention.

In the exemplary embodiment illustrated according to FIG. 1, each warning unit 1 has a separate cable 4, which is looped or led respectively through the segments 1, 2 located underneath and is led out of the warning lamp column according to the invention at a lower fixing element or fixing flange 5.

The cables 4 used are preferably thinly designed and advantageously have invisible or transparent electrical insulation.

Furthermore, in the example illustrated, the cables 4 are led loosely or hanging down freely within the warning units 1 and/or within the plinth 2, so that as far as possible no straight-line structure is generated which, surprisingly, is noticed substantially more easily by individuals then irregular or wavy, loose electric conductors 4 as illustrated in FIG. 1. In general terms, conductors 4 or conductor tracks 4 fixed firmly to the components 1, 2 can also be provided, which are advantageously not led in straight lines but as far as possible in a wavy or irregular manner within the components 1, 2 and warning units 1 and holding device 2 and/or to the column end or flange 5.

The warning units 1, the plinth 2 and a cover 7 and a flange 5 are advantageously fixed to one another. In FIG. 1, joints 6 are identified and preferably implemented with an advantageous adhesive as an adhesive joint 6. However, the joint 6 can be implemented not just in bonded form but also ultrasonically welded or by means of a similar joining method. A detachably fixable joint 6 can also be implemented, for example by means of appropriate recesses or milled-out portions at the ends, [lacuna]

In addition, a continuous or uniform sleeve according to the invention could be implemented with the last-named types of joint.

The embodiment of the invention illustrated in FIG. 1 can be produced particularly cost-effectively since, in this exemplary embodiment, standardized Plexiglas tubes, preferably having a round cross section and in a glass-clear design, which means without any light reflector effect or flutes or fluting or the like, are used. Accordingly, the warning lamp column according to the invention is not only particularly unobtrusive but can also be produced economically beneficially.

### LIST OF DESIGNATIONS

1 Warning unit
2 Plinth/foot/holding device
3 Light-emitting diode
4 Electric conductor/cable
5 Flange
6 Joint
7 Cover
8 Plexiglas tube segment/dome

What is claimed is:

1. Warning lamp column for the visual display of at least one operating state of a technical device such as a machine, a plant, a vehicle or the like, having at least one warning unit (1) comprising at least one warning lamp element and/or a light-emitting diode and/or a warning sound generator, in which a holding device (2) is arranged following the warning unit (1) in the direction of the longitudinal axis of the warning lamp column, the warning unit (1) having at least one sheath element (8) formed substantially as a tube element (8) for sheathing the warning lamp element and/or the light-emitting diode and/or the warning sound generator, characterized in that the holding device (2) and the sheath element (8) of the warning unit (1) are formed as column elements (1, 2, 8) transparent to visible light.

2. Warning lamp column according to claim 1 or in accordance with the preamble of claim 1, characterized in that the warning lamp column has a continuous, uniform shell (1, 2) extending substantially over the sheath elements (8) and the holding device (2).

3. Warning lamp column according to one of the preceding claims, characterized in that the holding device (2) is formed substantially from a tube element (2, 8) like the sheath element (8) of the warning unit (1), the tube element (2, 8) of the holding device (2), viewed in the direction of the longitudinal axis of the warning lamp column, having a different length than the tube element (2, 8) of the sheath element (8).

4. Warning lamp column according to one of the preceding claims, characterized in that the shell (1, 2, 8) and/or the tube elements (2, 8) of the sheath element/s (8) and of the holding device (2) have substantially the same external diameter.

5. Warning lamp column according to one of the preceding claims, characterized in that the holding device (2) and the sheath element (8) of the warning unit (1) are formed as a glass-clear tube element (2, 8).

6. Warning lamp column according to one of the preceding claims, characterized in that the warning unit (1) and/or the holding device (2) has at least one electric conductor (4) for conducting electric power and/or electric signals.

7. Warning lamp column according to one of the preceding claims, characterized in that the conductor (4) has at least one item of electrical insulation that is transparent to light and/or glass-clear.

8. Warning lamp column according to one of the preceding claims, characterized in that the electric conductor (4) has a conductor cross section less than or equal to 0.05 millimeters.

9. Warning lamp column according to one of the preceding claims, characterized in that the electric conductor (4) has a conductor cross section less than or equal to 0.01 millimeters.

10. Warning lamp column according to one of the preceding claims, characterized in that an adhesive (6) is provided to join the warning unit (1) and/or the sheath element (8) to the holding device (2) and/or to a further warning unit (1) and/or a further sheath element (8) and/or to a cover element.
